(19) United States
(12) Patent Application Publication
(10) Pub. No.: US 2025/0162248 A1
(43) Pub. Date: May 22, 2025

(54) OSCILLATORY STRAIN-ASSISTED VOXEL SHAPING AND JOINING FOR 3D-PRINTING

(71) Applicant: Keng Hsu, Phoenix, AZ (US)

(72) Inventor: Keng Hsu, Phoenix, AZ (US)

(21) Appl. No.: 18/954,128

(22) Filed: Nov. 20, 2024

Related U.S. Application Data
(60) Provisional application No. 63/601,092, filed on Nov. 20, 2023.

(51) Int. Cl. B29C 64/209; B29C 64/118; B33Y 10/00; B33Y 30/00

(52) U.S. Cl. CPC B29C 64/209; B29C 64/118; B33Y 10/00; B33Y 30/00

(57) ABSTRACT

An additive manufacturing system and method including feeding a filament material having a substantially circular cross-section through a capillary tool towards a substrate. The capillary tool oscillates simultaneously with feeding the filament material through the capillary tool. The filament material is compressed from an uncompressed state to a compressed state, wherein the compressed state has an increased width and decreased height compared to the uncompressed state. The capillary tool translates horizontally to form a first layer. The capillary tool translates vertically to form further layers upon the first layer until formation of a final component is formed. The final component is formed without melting of the filament material and the final component has an isotropic tensile strength of at least 90% of the filament material.

### CROSS-REFERENCE TO RELATED APPLICATIONS

This application claims the benefit of, and priority to, U.S. Provisional Patent Application No. 63/601,092, filed Nov. 20, 2023, the entire contents of which are incorporated herein by reference.

### BACKGROUND

Material shaping and joining are the two fundamental processes that lie at the core of many forms of metal manufacturing operations: formative processes like forging, additive processes like laser powder bed fusion, and welding operations like Metal Inert Gas (MIG) welding. Fundamentally, metal shaping, or permanent/plastic deformation, begins when the crystalline defects like dislocations in metals start to move along their slip planes. Joining, however, involves exchange of mass across boundaries or interfaces between adjacent domains of metal. Mass transfer processes such as diffusion or advective mixing drive the fusing of interfaces in joining. Shaping and joining both require energy input to overcome the initial energy barrier and to sustain continuation of these processes. In addition to energy input to drive these processes, additional energy can be used to assist these processes to allow for larger amounts of deformation, or to accelerate the diffusion behavior. Several forms of energy can be used to assist metal shaping and joining. In the case of metal shaping, many operations utilize heat energy to reduce hardening and to allow plastic deformation, or shaping, of metals at flow stresses lower than the static yield strength of material. Similarly, in joining, many processes use heat energy to create a molten pool of metals which is then joined as a result of the mass transfer happening in the melt pool. These processes are performed independently or sequentially to fabricate components and assemblies in manufacturing processes.

Three-dimensional (3D) printing can be broken down to two fundamental simultaneous steps: shaping and joining. Conventionally these steps are completed by heating, melting, and re-solidification of materials. These conventional methods are also energy inefficient. The 3D printing industry would benefit from 3D printing techniques with increased energy efficiency.

In conventional 3D printing, shaping and joining are performed either simultaneously or sequentially to produce components. In currently available metal additive manufacturing processes, this can be accomplished in a few ways. First, the process may use a high-power “point” heat source such as a focused laser or an electron-beam following a prescribed path to create a melt pool from metal powder or wire feedstock which fuses and subsequently solidifies to form solid objects line by line and layer by layer. Examples of technologies that use this process include the Selective Laser Melting (or Laser Powder Bed Fusion) and the Directed Energy Deposition techniques. Another method involves depositing metal particles with the help of a polymer binder which is then followed by steps to burn off the binder and sinter the metal particles together in the follow-on post-processes. Examples of this type of process include the Binder Jetting Additive Manufacturing, the Bound Metal Extrusion, and the Metal Nano Particle Jetting additive manufacturing technologies. Still a further possible approach to perform metal additive manufacturing is to use localized frictional heat fusion and mechanical strain to shape and join feedstock material into solids. Examples include the Ultrasonic Additive Manufacturing and the Friction Stir Additive Manufacturing technologies. While these processes have proven capabilities and applications, fundamentally the energy efficiency of these processes is severely limited because they rely on several energy conversion processes between energy input to material shaping and joining. Laser powder bed fusion for example, uses solid-state fiber lasers which operate at around 20% energy efficiency. The laser energy incident into the material then goes through another absorption loss due to metal absorptivity issues in both solid and liquid states. At this point the absorbed energy further sees losses into heat transfer from the laser incident zone into its surroundings before it serves the purpose of heating up the metal feedstock, forms the melt pool to accomplish shaping the joining. Additionally, the inefficiencies in the electrical energy to optical energy conversion process cause parasitic heating which, in turn, requires yet additional energy to dissipate in order to mitigate lasing issues. As a result, a laser powder bed fusion AM machine typically consumes 10-20 kW of power during operation, which translates to 300-500 MJ/Kg (or 1 MJ/cm3) of energy consumption for processing metals like aluminum alloys at the machine level. These energy inefficiency issues do not get any better in other thermal or melt-fusion based technologies. The 3D printing industry would benefit from 3D printing techniques with increased energy efficiency.

### SUMMARY

In some aspects, the techniques described herein relate to an additive manufacturing method comprising feeding a filament material having a substantially circular cross-section through a capillary tool towards a substrate, oscillating the capillary tool simultaneously with feeding the filament material through the capillary tool, compressing the filament material from an uncompressed state to a compressed state, wherein the compressed state has an increased width and decreased height compared to the uncompressed state, translating the capillary tool horizontally to form a first layer, translating the capillary tool vertically to form further layers upon the first layer until formation of a final component is formed, wherein the final component is formed without melting of the filament material, and wherein the final component has an isotropic tensile strength of at least 90% of the filament material.

In some aspects, the techniques described herein relate to an additive manufacturing method, wherein forming further layers includes offsetting adjacent layers by an overhang angle of 30 degrees.

In some aspects, the techniques described herein relate to an additive manufacturing method, wherein oscillating the capillary tool includes oscillating the capillary tool at 35-80 kHz at an amplitude of 1.0 micrometer.

In some aspects, the techniques described herein relate to an additive manufacturing method, wherein translating the capillary tool horizontally to form a first layer includes joining the compressed filament material to adjacent filament material through crystalline defect-enhanced diffusion near a surface of the compressed filament material.

In some aspects, the techniques described herein relate to an additive manufacturing method, wherein oscillating the capillary tool promotes atomic diffusion across an interface between the compressed filament material and the adjacent filament material.

In some aspects, the techniques described herein relate to an additive manufacturing method, wherein translating the capillary tool horizontally to form a first layer includes forming a perimeter and subsequently forming a diagonal infill.

In some aspects, the techniques described herein relate to an additive manufacturing method comprising feeding a filament material having a substantially circular cross-section through a capillary tool towards a substrate, oscillating the capillary tool simultaneously with feeding the filament material through the capillary tool, compressing the filament material from an uncompressed state to a compressed state, wherein the compressed state has an increased width and decreased height compared to the uncompressed state, translating the capillary tool horizontally to form a first layer, translating the capillary tool vertically to form further layers upon the first layer until formation of a final component is formed, wherein the final component is formed with an energy usage of less than 0.2 J/mm³, and wherein the final component has an isotropic tensile strength of at least 90% of the filament material.

In some aspects, the techniques described herein relate to an additive manufacturing system comprising a build plate and a hollow cylindrical capillary tool configured to translate relative to the build plate and vibrate along an axis parallel to the build plate, the hollow cylindrical capillary tool defining an opening through which the hollow cylindrical capillary tool being configured to deposit a solid metal wire on the build plate without melting the solid metal wire.

In some aspects, the techniques described herein relate to an additive manufacturing system, further including a controller programmed to oscillate the hollow cylindrical capillary tool and programmed to translate the hollow cylindrical capillary tool relative to the build plate.

In some aspects, the techniques described herein relate to an additive manufacturing system, wherein the hollow cylindrical capillary tool is configured to compress the solid metal wire from a substantially circular cross-section to a substantially rectangular cross-section having a width greater than a diameter of the circular cross-section and a height less than the diameter of the circular cross-section.

In some aspects, the techniques described herein relate to an additive manufacturing system, wherein the hollow cylindrical capillary tool is configured to deposit a first layer of the solid metal wire on the build plate and a second layer of the solid metal wire on the first layer, wherein the vibration of the hollow cylindrical capillary tool at the second layer redistributes native oxides on a surface of the solid metal wire and brings about nascent metal-to-metal contact at an interface between the first layer and the second layer.

In some aspects, the techniques described herein relate to an additive manufacturing system, wherein a density of a layer formed by the solid metal wire on the build plate is at least 99.95% of the density of the solid metal wire.

In some aspects, the techniques described herein relate to a method 13, wherein the part is formed with an energy usage of less than 0.2 J/mm³.

In some aspects, the techniques described herein relate to a method, wherein the hollow cylindrical capillary tool is oscillated at 35-90 kHz at an amplitude of 1.0 micrometer.

In some aspects, the techniques described herein relate to a method, wherein translating the capillary tool horizontally to form a first layer includes joining compressed solid metal wire to adjacent solid metal wire through crystalline defect-enhanced diffusion near a surface of the compressed solid metal wire.

Other aspects of the present subject matter will become apparent by consideration of the detailed description and accompanying drawings.

### BRIEF DESCRIPTION OF THE DRAWINGS

FIG. 1A is a schematic view of a capillary tool of a Resonance Assisted Deposition (RAD) apparatus and technique in operation.

FIG. 1B is a side view of the capillary tool in operation.

FIG. 1C is a perspective view of a first component formed by the RAD apparatus.

FIG. 1D is a perspective view of a second component formed by the RAD apparatus.

FIG. 1E is a perspective view of a third component formed by the RAD apparatus.

FIG. 2A is a perspective view of a fourth component formed by the RAD apparatus.

FIG. 2B is an enlarged view of a side surface of the component shown in FIG. 2A.

FIG. 2C is an enlarged view of a top surface of the component shown in FIG. 2A.

FIG. 2D is a perspective view of a fifth component formed by the RAD apparatus.

FIG. 3 is an example of a tool pathing strategy for printing components using the RAD apparatus.

FIG. 4A is an image of a printed component having insufficient overlap.

FIG. 4B is an image of a printed component having adequate overlap.

FIG. 4C is a scan of an as-printed component using micro commuted tomography (micro-CT).

FIG. 4D is an illustration of the size and shape of defects within the as-printed component of FIG. 4C with insufficient overlap.

FIG. 4E is an illustration of the size and shape of defects within the as-printed component of FIG. 4C with adequate overlap.

FIG. 5A is a graph comparing the ultimate tensile strength of horizontal and vertical test coupons.

FIG. 5B is a graph comparing the elongation of horizontal and vertical test coupons printed with the RAD technique.

FIG. 5C is a side view of the horizontal test coupon upon failure.

FIG. 5D is a perspective view of a fracture surface of the horizontal test coupon upon failure.

FIG. 5E is a side view of the vertical test coupon upon failure.

FIG. 5F is a perspective view of a fracture surface of the vertical test coupon upon failure.

FIG. 6A is a first view illustrating components printed with the RAD technique at various overhang angles.

FIG. 6B is a second view illustrating components printed with the RAD technique at the various overhang angles.

FIG. 7A is a thermal image of the capillary tool and filament during operation.

FIG. 7B is a graph illustrating a temperature rise of the RAD apparatus during operation.

FIG. 8A is a STEM Image of an Al—Ni interface formed by using the RAD technique.

FIG. 8B is an EDS scan across the Al—Ni interface showing relative changes in atomic percentages across the interface.

FIG. 9A is a bright field TEM image of the interface of pure AL and pure Ni joined using the RAD technique.

FIG. 9B illustrates a further region of high defect density.

FIG. 9C illustrates a still further region of high defect density.

Before any embodiments of the present subject matter are explained in detail, it is to be understood that the present subject matter is not limited in its application to the details of construction and the arrangement of components set forth in the following description or illustrated in the following drawings. The present subject matter is capable of other embodiments and of being practiced or of being carried out in various ways.

### DETAILED DESCRIPTION

Described herein is a method of applying two forms of mechanical energy (static compression in larger displacement and a repeated shear deformation in the orthogonal direction to the first in a small displacement) to simultaneously shape a section of a wire feedstock into a desired shape while joining it to a build surface, a lower layer, or a neighboring vertical surface. This method is referred to herein as Resonance Assisted Deposition (RAD). As these joints are made consecutively along the axial direction of the wire feedstock material, a track of material is deposited. This process is repeatable in the plane directions as well as in the vertical direction following a prescribed path to form a 3-dimensional object. 3D printing using this method is 50 to 1,000 times more energetically efficient than conventional methods that rely upon heating, melting, and re-solidification of the build materials.

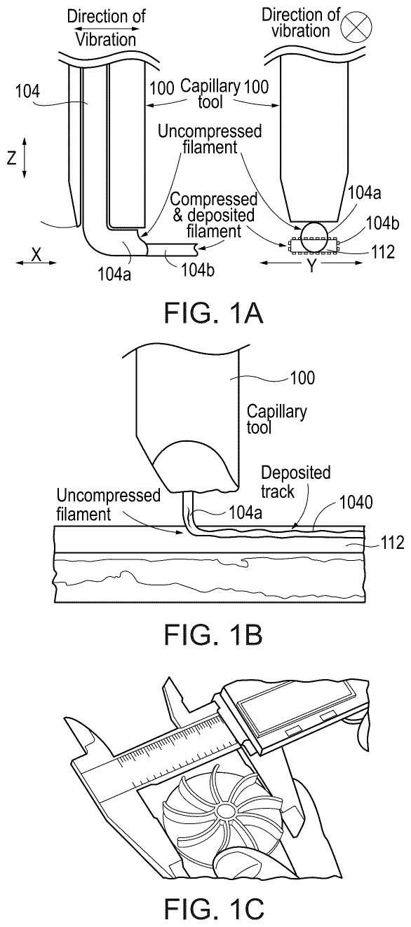

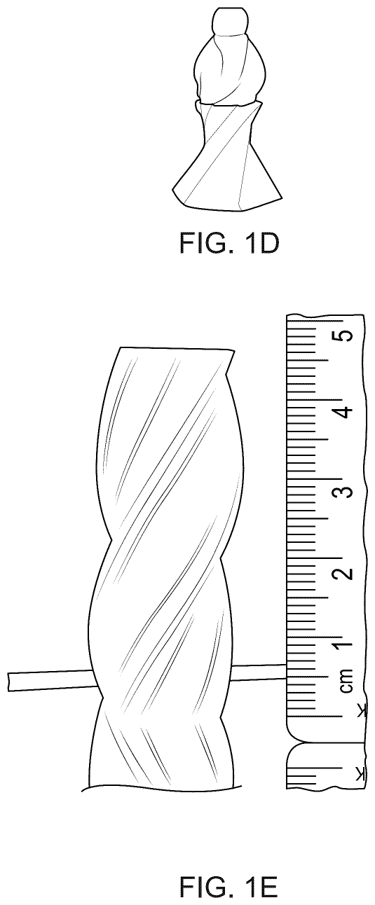

RAD is a method of metal 3D printing by continuously shaping and joining metal voxel simultaneously in solid state that is significantly more energy efficient than using heat energy and melting. The RAD method introduced here uses two mechanical oscillatory strain-based physical mechanisms to assist shaping and joining. To implement the RAD method into a system to produce a 3D metal object, a mechanical system is set up to use a hollow cylindrical capillary tool to move a solid metal fine wire in space and turn it into “voxels” through “compression cycles” sequentially to form lines, layers, and a complete 3-dimensional part at the end. Shown in FIG. 1A is an example of such a setup. A capillary tool 100 is shown in FIG. 1A in two different orientations. A first orientation illustrates the capillary tool 100 with the direction of vibration of the capillary tool 100 to the left and right of the image (along the x-axis). A second orientation illustrates the capillary tool in an orientation perpendicular to the first with the direction of vibration into and out of the page (perpendicular to the y-axis). The filament 104 is fed out an opening 108 at a distal end of the capillary tool 100 onto a build plate 112 (or other build surface or previous filament layer) and is compressed from an uncompressed filament 104a in which the filament has a substantially circular cross-section to a compressed filament 104b in which the filament has a substantially rectangular cross-section. The width of the compressed filament 104b (perpendicular to the direction of vibration and the vertical feed axis of the capillary tool 100) is substantially wider than the width of the uncompressed filament 104a. The height of the compressed filament 104b (parallel to the vertical feed axis of the capillary tool 100) is substantially decreased compared to the uncompressed filament 104a.

In the RAD metal 3D printing process, each compression cycle is the basic step that produces a voxel. In a compression cycle, the feedstock is brought to a desired location and compressed in the direction orthogonal to its axis to shape the cross-section of the wire from a circular shape to rectangular while a high-frequency oscillatory shear strain (typically 35-80 kHz at roughly 1.0 micrometer, e.g., 0.5-1.5 micrometer, amplitude) along the wire axis direction is simultaneously applied. Simultaneously during shaping of a voxel in each compression cycle, the voxel is joined to all surrounding voxels through crystalline defect-enhanced diffusion near its surfaces. Once at the bottom position of its compression cycle, the tool lifts and moves along the wire axis direction by a prescribed “step size” to begin the next compression cycle of producing the next voxel.

The capillary tool vibrates at an ultrasonic frequency, thereby compressing the filament feedstock to deposit one voxel of material. The capillary tool then moves upward in the Z-direction (i.e., along the feed axis of the capillary tool) to deposit the next voxel. The deposition is repeated until a track of material is deposited. Several adjacent tracks form a layer of material. FIG. 1B illustrates a track of material being deposited by the capillary tool. FIGS. 1C, 1D, and 1E illustrate various parts formed using the RAD process. In the instant example, the parts are made of 6061 aluminum.

In some embodiments, the capillary tool 100 is coupled to the build plate via a gantry or a robotic arm. A controller, such as a controller programmed via software to generate the desired part, is programmed to control movement of the capillary tool 100, including movement relative to the build plate 112 (both parallel to the build plate, perpendicular to the build plate, and in some embodiments, at an angle incorporating both parallel and perpendicular vectors, and rotation) and oscillation/vibration characteristics such as frequency and amplitude. The controller may communicate with the capillary tool via a wired or a wireless connection.

The imposed oscillatory shear strain puts the material in an elevated energy state and thereby mobilizes the lattice dislocations within the voxel. Being in an activated state, these mobilized dislocations move readily when a superimposed static compression strain (in the compression cycle) is applied. In addition, the oscillatory shear strain energy enables faster annihilation of dislocations resulting in reduced hardening and lowering of flow stress required to plastically deform the metal. Oscillatory shear strain imposed on the voxel also causes friction at the feedstock-substrate interface (or feedstock-lower layer interface), but only during the initial few milliseconds. Because the voxel initially has a circular cross-section, the area of contact between the voxel and the stiff capillary tool surface applying the oscillatory strain and compressive force is small, allowing for relative movement between the interfaces including the voxel-material interface. As the voxel gets compressed and shaped, the area of contact increases continuously until a point is reached when the relative movement between the surfaces stops, and the voxel experiences purely oscillatory shear strain. It is at this point that the frictional heat on interfaces ceases to be generated. The frictional heat that was generated in the initial few milliseconds is not sufficient to cause a significant increase in the temperature of the voxel. However, the combination of this friction and the increase in surface area because of the shape change allows breaking and redistribution of native oxides on the surface of the wire feedstock and bring about nascent metal-to-metal contact at the interface.

Simultaneously as the voxel is being compressed and shaped, the second crystalline defect and oscillatory shear strain-based phenomenon promotes atomic diffusion across the interface which allows joining of a voxel to neighboring ones. Since the metal voxel is in an elevated energy state due to the imposed oscillatory shear strain, the energy barrier to atomic diffusion and mass transfer is subsequently lowered. Additionally, the chemical potential that is also required for atomic diffusion is also raised across voxel-voxel boundaries because of the crystalline defect density gradient across the same interfaces. Combined with inherently high crystalline defect density near interfaces, the mass transfer across voxel interfaces, and therefore joining, is orders of magnitude higher in magnitude than what would be expected due to thermal diffusion at the temperatures at which the process occurs. This translates to either increased diffusion length across the interfaces, or reduced time needed for joining to occur.

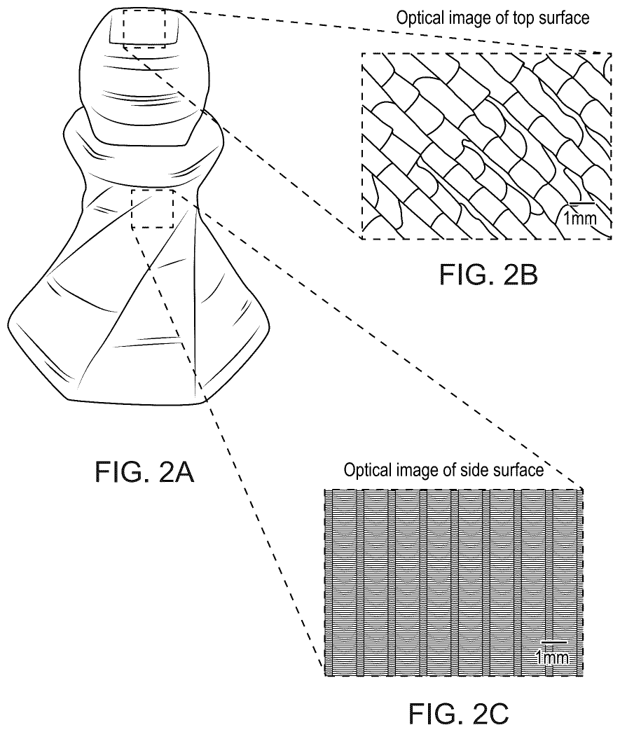

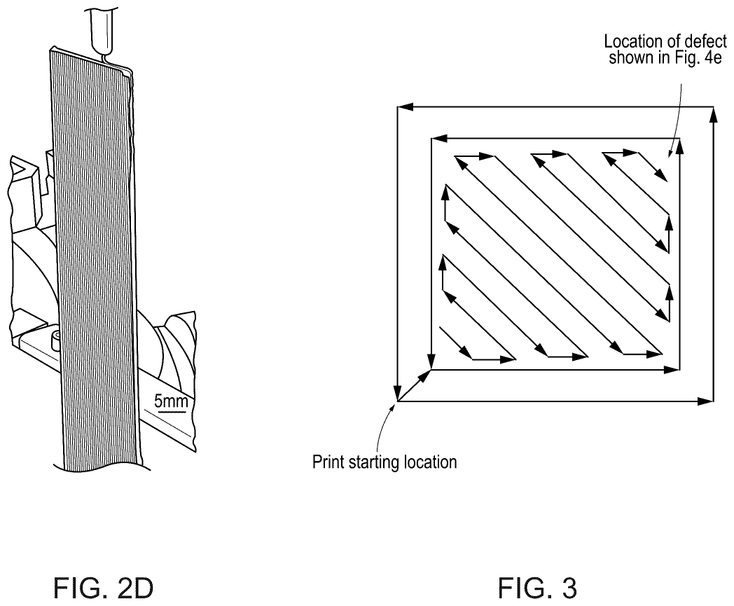

As the compression cycles repeat along a prescribed linear motion, a line of metal is deposited and welded onto the previous layer (or an existing surface). The lines can be of any pattern to either encompass the boundaries of an enclosed area or tracks with a given width to fill up the interior space of the enclosed area until a layer of material is completed. Much like conventional 3D printing processes, this layer-by-layer process repeats in a given direction, typically referred to as the print direction, to form a 3-dimensional object. FIG. 1C illustrates three examples of objects constructed using this approach. As shown in FIGS. 2B and 2C, the top surface (FIG. 2B) of printed metal parts (i.e., the surface orthogonal to the print direction) has different surface morphology as compared with the side surfaces (FIG. 2C) parallel to the build direction. The top surface morphology is dictated by the tooling surface in contact with the metal voxel during each compression cycle, as well as the material flow and track-to-track overlaps in the tool path. The bottom surface morphology of the build is determined by the joint strength between the first layer of the printed part and the build plate, and how it is separated from the build plate. The side surfaces have a characteristic “scalloping” effect similar to what is typically seen in the Fused Filament Fabrication polymer 3D printing method as large amounts of material strain is experienced by the feedstock material during the printing process.

With the RAD technique and method, the ratio of voxel height (also layer height) to feedstock diameter is between 0.28 to 0.43. While the exact ratio is dictated by the amount of compression required in each compression cycle to establish full space filling between adjacent tracks and proper joining of interfaces, this ratio also determines the extent of the scallops on the side surfaces. The larger the layer height, the higher the waviness on the sidewalls. Within the feasible parameter range, the resulting roughness values of top surfaces are typically around 10-20 micrometers Ra, while the side surfaces are in the range of 20-30 micrometers Ra. The as-printed surfaces of a part can also be processed using conventional surface process tools such as sanding, bead blasting, tumbling, etc. Depending on the accuracy and repeatability of the motion system into which the tooling is integrated, the tolerances of features in a built part can vary. On a typical linear bearing and ball screw based Cartesian motion system, the tolerance of a printed part can fall within +/−50-100 micrometers given that the toolpaths are generated with precisions down to 1 micrometer or less. Additionally, The RAD technique offers a unique capability of printing articles with very high aspect ratio (i.e., thin-walled, tall structures) as shown in FIG. 2D. This capability can be attributed to the absence of residual stresses in the printed parts.

Parts printed using the RAD technique typically have finer grains in comparison with the feedstock. The large amount of strain experienced by the metal in each compression cycle during the process causes grain refinement similar to what is typically seen in deformation-based manufacturing processes such as forming. A unique feature of the RAD-printed parts is that the grain refinement is not nearly as much as those seen in processes like cold rolling/drawing, but rather, similar to typical warm or hot working conditions. This behavior is linked to the observed reduction in the apparent flow stress of material during each compression cycle and can be rationalized by considering the increased dislocation annihilation in the material which counteracts the dislocation multiplication process that refines the grain sizes. It is possible to locally control the grain size down to each voxel by altering the rate of compression strain, or the amplitude of oscillatory movements of the tool as the grain refinement process is confined locally to each compression cycle.

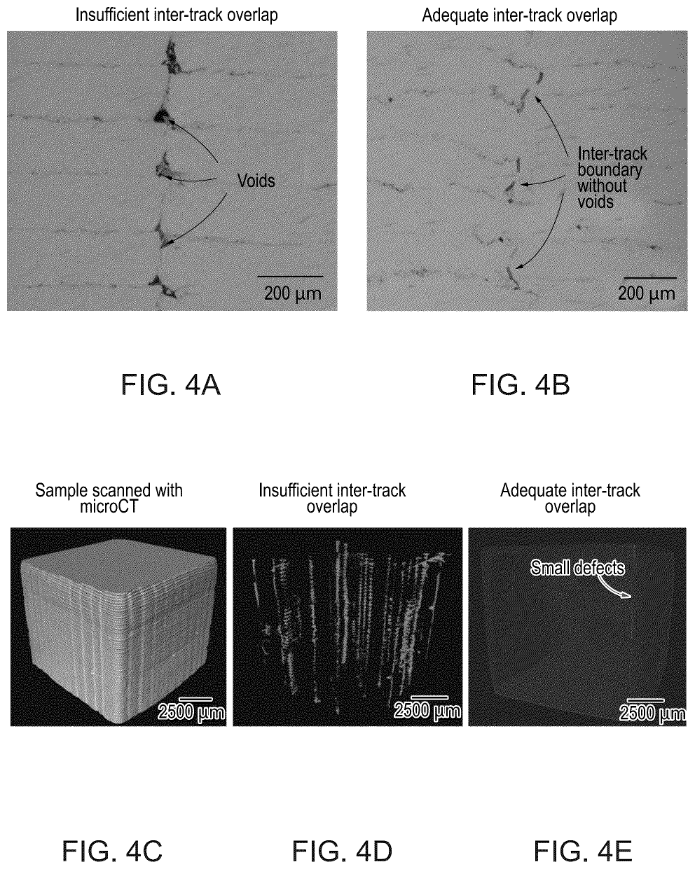

In each compression cycle the feedstock is compressed in the build direction to the voxel height as it expands laterally to form the voxel width. In condition this width is more than the spacing between the parallel tracks in the toolpath to fill in the space within an enclosed area (referred to as the inter-track overlapping), complete space filling of the cross-section is achieved. FIG. 3 illustrates a tool-pathing strategy used for printing components. The strategy includes forming two outer walls with a +45 degree/−45 degree infill. The outer walls may be printed first followed by the infill. FIGS. 4A-4E illustrate examples of cross-sectional space filling with and without adequate overlapping. Insufficient overlapping is shown in FIG. 4A and results in voids between the adjacent tracks. Adequate overlapping is shown in FIG. 4B, with no voids at the inter-track boundaries. Under these conditions, we observe that the lateral flow of material enables the spaces between a track of metal and its neighboring tracks to be completely filled, and the overall density of a build part reaches 99.95% or greater of that of the feedstock material. FIG. 4C illustrates the geometry of an as-printed sample, scanned with micro computed tomography (micro-CT). The internal defect structure of insufficient overlap is illustrated in FIG. 4D, the highlighted portions illustrating the size and shape of the defects. With adequate overlap, the number and size of the defects is significantly reduced, as shown in FIG. 4E.

Mechanical properties of parts built using the RAD technique reflect directional and locational differences in both the grain geometry and size distribution in the built material. Near the voxel boundaries in the build direction the grain sizes are significantly smaller. As a result of this non-uniform grain size distribution, the overall material is spatially made of metals of two different properties: a finer grain region with higher strength but lower ductility, and a coarser grain region with lower strength but high ductility, where the finer grain regions are sandwiched between layers of coarser grain regions. Effectively this is similar to alternating layers of reinforcing agent and a softer matrix phase in composite materials. The overall result is that the mechanical property of a RAD part is directionally dependent on the relative orientation between the load and the stronger phase, or the finer grain regions, in the built material. This behavior is evident in the fracture behavior of printed tensile specimens when the load direction is orthogonal to the build direction as in FIGS. 4A-4E. In the fracture surfaces one can clearly observe the extensive plastic deformation in the regions between the layer-to-layer interfaces, while the interface regions exhibit significantly lower ductility. On the other hand, the overall fracture behavior of built material exhibits less ductility when the tensile load is applied along the build direction.

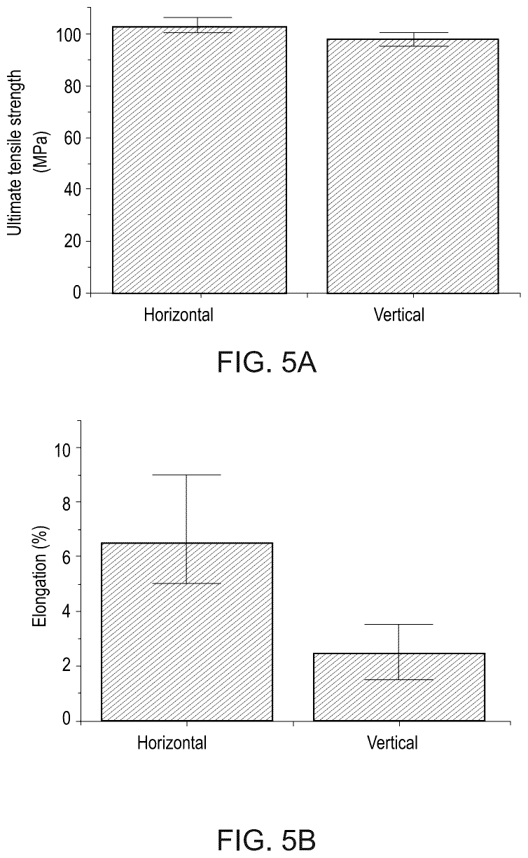

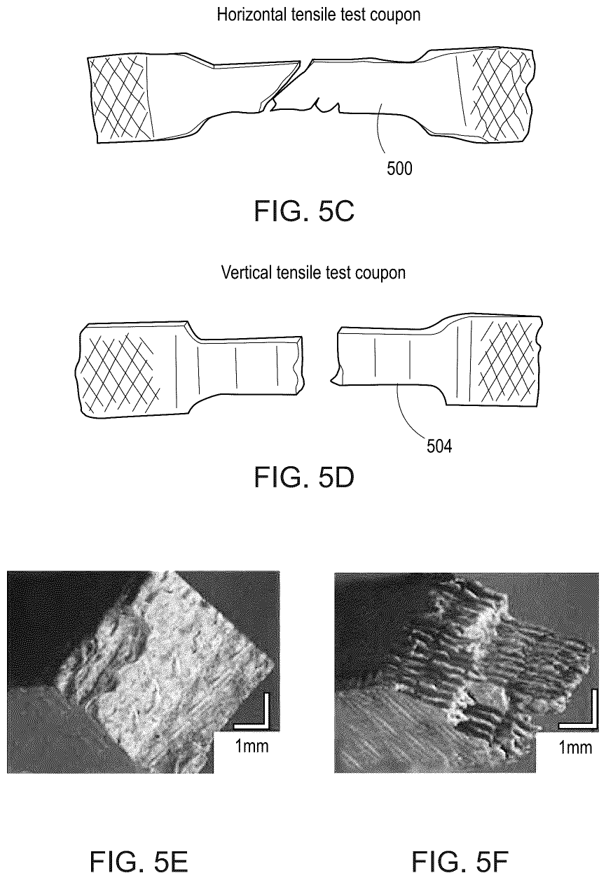

FIGS. 5A and 5B illustrate the ultimate tensile strength (UTS) and elongation values of horizontal and vertical test coupons, respectively. Test coupons are used for testing purposes to obtain comparable test data. The test coupons are representative to two identical components printed in different orientations. The horizontal test coupon 500 is printed flat such that the dog-bone-shaped profile is built horizontally on the build surface (the thickness of the dog-bone-shaped profile representing the vertical build layers). The vertical test coupon 504 is printed vertically such that the dog-bone-shaped profile is built standing vertically upward from the build surface. As shown, the horizontal test coupon 500 (illustrated in FIG. 5C) has a greater UTS (e.g., 10% greater, 5%-15% greater, at least 5% greater) than the vertical test coupon 504 (illustrated in FIG. 5E) and greater elongation (e.g., 4%, 2%-6%, at least 3%) than the vertical test coupon 504. FIGS. 5D and 5F illustrate the fracture surface of the test coupons 500, 504. As shown in FIG. 5D, the horizontal test coupon 500 fractures showing the individual layers, while, as shown in FIG. 5F, the vertical test coupon 504 fractures at (or substantially at) the interface between successive layers.

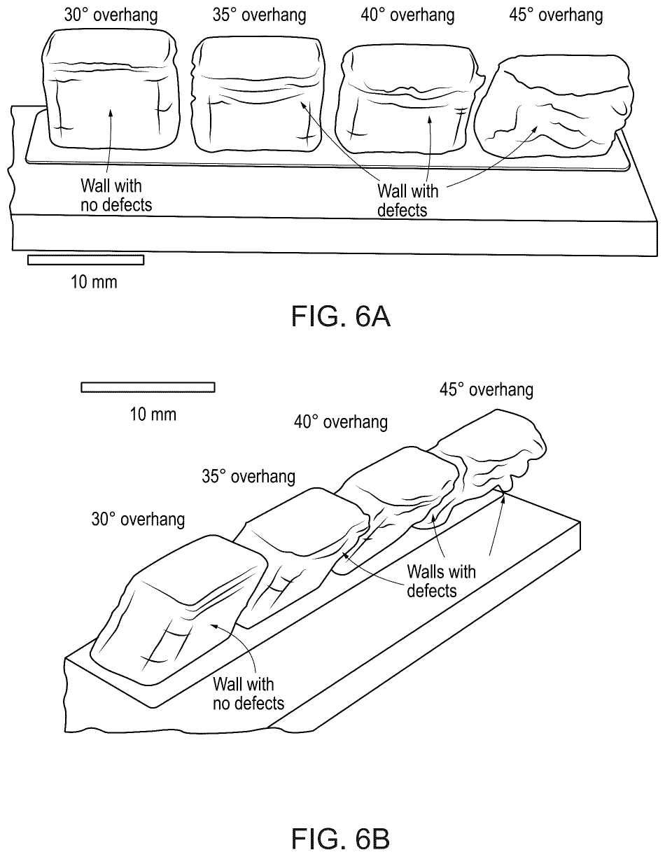

FIGS. 6A and 6B illustrate parallelograms printed having various overhang angles. The overhang angle is the angle made by the walls relative to vertical. Four samples are shown. The first sample has a 30 degree overhang (creating a sidewall extending outward and upward from the base at a 30 degree angle relative to vertical) and the outer wall shows no defects. The three further samples include 35 degree, 40 degree, and 45 degree overhang angles, respectively, and illustrate increasing degrees of deformation and defects within the wall surface. Based on the samples, parts having an overhang angle of up to degrees are reliably printed with the RAD technique.

The RAD technique and method form a basis for a new metal 3D printing technology that is extremely energy efficient, capable, and accessible. In engineering design and prototyping environments, this technology can be developed and positioned to operate right inside a design office/studio alongside typical office appliances such as paper printer, photo copier, etc. where conventional metal 3D printers cannot. In small to medium scale metal parts production environments, it is particularly suited for “print farm” type of configuration where instead of a large system/machine producing parts in series, many 3D printers based on this technique are used to produce a smaller number of parts each. In addition, machines based on this technique can be developed into deployable configurations where they operate in remote locations with extremely limited resources or extreme environments, examples of such scenarios are disaster sites, forward operating bases, and in space.

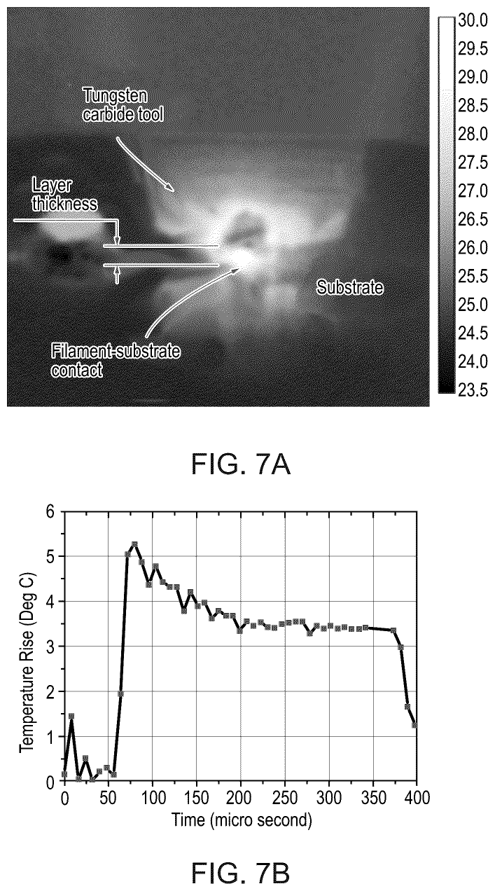

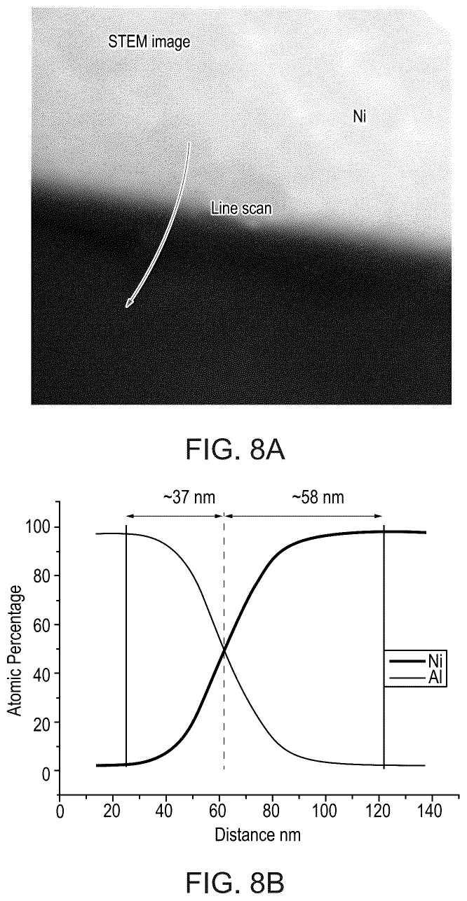

FIG. 7A illustrates a single frame of a thermal video of cross-section view of the capillary tool, filament, and substrate during RAD voxel formation. Spatial temperature distribution is shown at the time point where the maximum temperature is reached (at the filament-substrate contact) in the field of view. The temporal evolution of the temperature at the filament-substrate contact is shown in FIG. 7B. The entire voxel formation time is 0.3 seconds. Two main heat sources in RAD are the frictional heating on the filament-voxel interface and the cyclic plastic strain coupling into heat dissipation. Frictional heat starts as the voxel formations begins. The frictional heat terminates as the metallurgical bonds form at approximately 30 milliseconds into the process. The cyclic plastic strain heating goes on until the ultrasound vibration stops at the conclusion of the voxel formation. FIG. 8A illustrates a STEM Image of an Al—Ni interface formed by using the proposed RAD technique. FIG. 8B illustrates an EDS scan across the Al—Ni interface showing relative changes in atomic percentages across the interface.

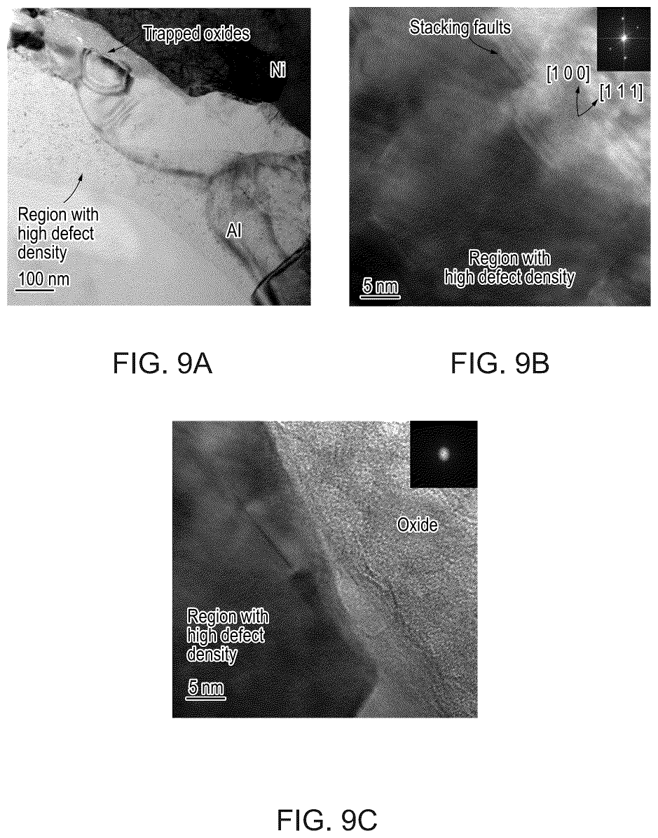

FIG. 9A illustrates a bright field TEM image of the interface of pure Al and pure Ni joined using the RAD technique. Initial oscillatory strain breaks the oxide layer off Al. In some cases, the oxide gets trapped in the inter-layer interface as shown in the image. The region near the interface with high crystalline defect density in Al is shown. High-resolution TEM images of this region with high defect density are shown in FIGS. 9B and 9C, illustrating crystalline defects.

The RAD technique uses high-frequency, small-amplitude oscillatory strains to shape and join segments of a solid metal wire into layers of enclosed areas of metal material. Combined with the ability to control the timing and positioning in space of such shaping and joining, RAD is shown to be capable of producing 3D metal objects without heating or melting of the metal feedstock. As compared with conventional melt-fusion based metal 3D printing techniques such as the Laser Powder Bed Fusion (LPBF), the energy efficiency of the RAD technique at the voxel level is approximately more than 1000 times higher. LPBF has an energy use of approximately 100 J/mm³. In contrast, RAD, has an energy use of less than 0.2 J/mm³ (e.g., 0.1 J/mm³). 6,061 aluminum objects produced using the RAD technique are shown to have 99.95% as-built specific density. RAD produced parts have isotropic tensile strengths within 95% (e.g., at least 90%) of that of the feedstock material (105 MPa for 6061-O feedstock, 97-103 MPa for as-built RAD parts using this feedstock). Without a supporting materials and structure, the RAD technique is capable of producing features at 30 degrees overhang (with respect to vertical), and the overall as-built surface finish falls within 10-30 microns Ra. While the current minimum feature size is in the 1 millimeter range, the aspect ratio of RAD parts can exceed 50 millimeters. The RAD technique provides a significant advancement in energy-efficient metal 3D printing and represents a leap forward in the vision of point-of-use/point-of-need metal 3D printing in application such as disaster relief in emergency situations, logistics support for forward operating bases, and in-space manufacturing, mobility, and logistics.

Although the present subject matter has been described in detail with reference to certain preferred embodiments, variations and modifications exist within the scope of one or more independent aspects of the subject matter as described.

1. An additive manufacturing method comprising:
feeding a filament material having a substantially circular cross-section through a capillary tool towards a substrate;
oscillating the capillary tool simultaneously with feeding the filament material through the capillary tool;
compressing the filament material from an uncompressed state to a compressed state, wherein the compressed state has an increased width and decreased height compared to the uncompressed state;
translating the capillary tool horizontally to form a first layer; and
translating the capillary tool vertically to form further layers upon the first layer until formation of a final component is formed,
wherein the final component is formed without melting of the filament material, and
wherein the final component has an isotropic tensile strength of at least 90% of the filament material.

2. The additive manufacturing method of claim 1, wherein forming further layers includes offsetting adjacent layers by an overhang angle of 30 degrees.

3. The additive manufacturing method of claim 1, wherein oscillating the capillary tool includes oscillating the capillary tool at 35-80 kHz at an amplitude of 1.0 micrometer.

4. The additive manufacturing method of claim 1, wherein translating the capillary tool horizontally to form a first layer includes joining the compressed filament material to adjacent filament material through crystalline defect-enhanced diffusion near a surface of the compressed filament material.

5. The additive manufacturing method of claim 4, wherein oscillating the capillary tool promotes atomic diffusion across an interface between the compressed filament material and the adjacent filament material.

6. The additive manufacturing method of claim 1, wherein translating the capillary tool horizontally to form a first layer includes forming a perimeter and subsequently forming a diagonal infill.

7. An additive manufacturing method comprising:
feeding a filament material having a substantially circular cross-section through a capillary tool towards a substrate;
oscillating the capillary tool simultaneously with feeding the filament material through the capillary tool;
compressing the filament material from an uncompressed state to a compressed state, wherein the compressed state has an increased width and decreased height compared to the uncompressed state;
translating the capillary tool horizontally to form a first layer; and
translating the capillary tool vertically to form further layers upon the first layer until formation of a final component is formed,
wherein the final component is formed with an energy usage of less than 0.2 J/mm³, and
wherein the final component has an isotropic tensile strength of at least 90% of the filament material.

8. The additive manufacturing method of claim 7, wherein forming further layers includes offsetting adjacent layers by an overhang angle of 30 degrees.

9. The additive manufacturing method of claim 7, wherein oscillating the capillary tool includes oscillating the capillary tool at 35-80 kHz at an amplitude of 1.0 micrometer.

10. The additive manufacturing method of claim 7, wherein translating the capillary tool horizontally to form a first layer includes joining the compressed filament material to adjacent filament material through crystalline defect-enhanced diffusion near a surface of the compressed filament material.

11. The additive manufacturing method of claim 10, wherein oscillating the capillary tool promotes atomic diffusion across an interface between the compressed filament material and the adjacent filament material.

12. The additive manufacturing method of claim 7, wherein translating the capillary tool horizontally to form a first layer includes forming a perimeter and subsequently forming a diagonal infill.

13. An additive manufacturing system comprising:
a build plate; and
a hollow cylindrical capillary tool configured to translate relative to the build plate and vibrate along an axis parallel to the build plate, the hollow cylindrical capillary tool defining an opening through which the hollow cylindrical capillary tool is configured to deposit a solid metal wire on the build plate without melting the solid metal wire.

14. The additive manufacturing system of claim 13, further comprising a controller programmed to oscillate the hollow cylindrical capillary tool and programmed to translate the hollow cylindrical capillary tool relative to the build plate.

15. The additive manufacturing system of claim 13, wherein the hollow cylindrical capillary tool is configured to compress the solid metal wire from a substantially circular cross-section to a substantially rectangular cross-section having a width greater than a diameter of the circular cross-section and a height less than the diameter of the circular cross-section.

16. The additive manufacturing system of claim 13, wherein the hollow cylindrical capillary tool is configured to deposit a first layer of the solid metal wire on the build plate and a second layer of the solid metal wire on the first layer, wherein the vibration of the hollow cylindrical capillary tool at the second layer redistributes native oxides on a surface of the solid metal wire and brings about nascent metal-to-metal contact at an interface between the first layer and the second layer.

17. The additive manufacturing system of claim 13, wherein a density of a layer formed by the solid metal wire on the build plate is at least 99.95% of the density of the solid metal wire.

18. A method of forming a part via the additive manufacturing system of claim 13, wherein the part is formed with an energy usage of less than 0.2 J/mm³.

19. The method of claim 18, wherein the hollow cylindrical capillary tool is oscillated at 35-90 kHz at an amplitude of 1.0 micrometer.

20. The method of claim 18, wherein translating the capillary tool horizontally to form a first layer includes joining compressed solid metal wire to adjacent solid metal wire through crystalline defect-enhanced diffusion near a surface of the compressed solid metal wire.
